(19) United States
(12) Patent Application Publication
(10) Pub. No.: US 2026/0306887 A1
(43) Pub. Date: Oct. 8, 2026

(54) FIRE EXTINGUISHER PIN PULL SENSOR

(71) Applicant: BCAI Solutions Pty Ltd, Adelaide (AU)

(72) Inventors: Nathan Brown, Adelaide (AU); Zhang Lei, Singapore (SG)

(21) Appl. No.: 19/108,158

(22) PCT Filed: Apr. 26, 2024
(86) PCT No.: PCT/AU2024/050403

§ 371 Date: Mar. 1, 2025

(30) Foreign Application Priority Data
Oct. 16, 2023 (AU) 2023903299

(51) Int. Cl. A62C 13/76; A62C 13/00; G08B 21/18

(52) U.S. Cl. CPC A62C 13/76; A62C 13/003; G08B 21/18

(57) ABSTRACT

The present invention relates to a pin pull sensor assembly for detecting removal of a locking pin from the handle of a portable fire extinguisher, wherein the assembly includes an aperture for accommodating the end of the locking pin. The assembly includes a biased cam arrangement moveable between a first position in which the end of the fire extinguisher pin is inserted in the aperture, and a second position in which the end of the fire extinguisher pin is not inserted. The cam arrangement is biased towards the second position such that the cam arrangement is caused to move from the first position to the second position when the end of the pin is removed from the aperture, enabling a limit switch or similar device to detect that the cam arrangement is no longer in the first position.

### FIELD OF THE INVENTION

The present invention relates to a fire extinguisher pin pull sensor assembly and, in particular, to an assembly configured to detect removal of a locking pin that requires removal from a fire extinguisher handle in order to arm the fire extinguisher. The present invention further relates to a fire extinguisher incorporating the pin pull sensor assembly, and a computer-implemented system and method of remotely detecting removal of a fire extinguisher locking pin.

### BACKGROUND OF THE INVENTION

Portable fire extinguishers are well known devices that are operable to extinguish fires and, in particular, provide users with the ability to quickly and safely extinguish a small fire preventing its spread and major damage to property. Such extinguishers are typically mounted on walls and in other easy to access areas throughout homes and buildings to facilitate access to such devices in the event of a fire. Fire extinguishers will typically contain a material that is suitable for extinguishing a particular fire.

Some examples of extinguishing materials (also referred to as extinguishing agents) include water for class A (eg. paper and wood) fires, foam for class A, class B (eg. paint and petrol) and to a limited extent class F (eg. fryers and chi pans) fires, dry chemical powder ABE for class A, class B and class E (eg. computers and generators) fires, dry chemical powder BE for class B, class E and to a limited extent class F fires, Carbon Dioxide (CO2) for class E and to a limited extent class A and class B fires, and wet chemical for class A and class F fires.

A fire extinguisher typically comprises a cylindrical body containing pressurized fire extinguishing material, a pressure indicator gauge at the top of the cylinder indicating the pressure inside (or at least whether the pressure is within a safe zone), a handle and associated valve assembly, and a discharge hose which typically includes a nozzle through which fire extinguishing material passes when the valve assembly is operated by activating the handle. The handle typically includes a carry handle portion that allows for easy grasping, lifting and carrying of the extinguisher, and an operating lever handle portion configured to be depressed (squeezed) towards the carry handle portion to activate the valve assembly. Most fire extinguishers also include a pull pin (also known as a locking pin) that is inserted into the valve portion of the extinguisher and requires removal to arm the extinguisher ready for use. This pin is typically located such that the operating lever handle portion is not capable of being depressed to open the valve whilst the pin remains inserted. The pin also prevents accidental discharge (eg. by accidentally squeezing the operating lever when attempting to carry the fire extinguisher to another location).

The fire extinguisher pins need to be regularly inspected (eg. annually) for functionality, which often involves checking to determine whether the pin has been tampered with (eg. partially or fully removed) in a manner that may cause the fire extinguisher to no longer comply with relevant Standards and/or prevent the fire extinguisher from being properly used. Such manual inspections typically require significant resources and hence are costly.

There is a need to be able to monitor the status, including the unauthorized tampering (partial or complete removal), of such pins so that appropriate action can be taken to address problems associated with the pin, without the need for regular site inspections.

Another problem arises from the use of conventional portable fire extinguishers in that portable extinguishers that are known to the Applicant are not generally capable of providing notifications to relevant responders and/or on-site personnel regarding the status of the locking pin, including unintentional arming of fire extinguishers, so that remedial action can be taken as quickly as possible.

The present invention seeks to mitigate the problems discussed herein, or at least provide an alternative solution.

The reference to any prior art in this specification is not, and should not be taken as, an acknowledgement or any suggestion, that the prior art forms part of the common general knowledge.

### SUMMARY OF THE INVENTION

In one aspect, the present invention provides a pin pull sensor assembly for a fire extinguisher including a handle to operate the fire extinguisher, the handle including a pin positioned to prevent the handle from operation such that arming the fire extinguisher requires removal of the pin, the pin pull sensor assembly including, an aperture for accommodating an end of the pin that is removeable from the fire extinguisher handle to arm the fire extinguisher, a biased cam arrangement that is moveable between, a first position in which, the end of the fire extinguisher pin resides in the aperture, a first cam element of the cam arrangement is biased towards the aperture and abuts against the inserted pin which resides in the path of the first cam element, and a second cam element of the cam arrangement is positioned to enable a device for detecting movement of the cam arrangement to detect when the cam arrangement is in the first position, and a second position in which, the end of the fire extinguisher pin is removed from the aperture, and the second cam element is positioned to enable the device for detecting movement of the cam arrangement to detect that the cam arrangement is not in the first position, and wherein the cam arrangement is biased toward the second position such that the cam arrangement is caused to move from the first position to the second position when the end of the pin is removed from the aperture, thereby enabling the device for detecting movement of the cam arrangement to detect that the cam arrangement is not in the first position.

In an embodiment, the cam arrangement is rotatably moveable between the first and second positions, and the device for detecting movement of the cam arrangement is a device for detecting rotation of the cam arrangement.

In an embodiment, the device for detecting rotation of the cam arrangement is a limit switch.

In an alternative embodiment, the device for detecting rotation of the cam arrangement is a proximity sensor configured to be actuated based on detecting the presence of the cam arrangement within a predetermined vicinity of the proximity sensor.

In an embodiment, the limit switch is configured to detect that the cam arrangement is in the first position based on a limit switch actuator being closed by the second cam element when the cam arrangement is in the first position.

In an embodiment, the limit switch is configured to detect that the cam arrangement is in the second position based on the second cam element being rotated away from the limit switch to an extent that causes the limit switch actuator to be opened.

Accordingly, when the device for detecting movement of the cam arrangement is a limit switch, then according to the particular embodiment described herein, the limit switch is normally closed when the pin is inserted, and is opened when the second cam element rotates away from the limit switch as a result of the cam arrangement rotating from the first to the second position. Such switches typically only require the limit switch actuator (eg. a limit switch pin) to be displaced by approximately 1 mm in order to transition from “closed” to “opened”.

In the case of a proximity sensor, the detected presence of the second cam element within a particular vicinity of the sensor (when the pin is inserted) is sufficient to cause the proximity sensor to be closed, whilst movement of the second cam element out of the particular vicinity (when the pin is removed) is sufficient to cause the proximity sensor to be opened.

In an alternative embodiment, the limit switch is configured to detect that the cam arrangement is in the first position based on a limit switch actuator being opened by the second cam element when the cam arrangement is in the first position.

In the alternative embodiment, the limit switch is configured to detect that the cam arrangement is in the second position based on the second cam element being rotated towards the limit switch to an extent that causes the limit switch actuator to be closed.

Accordingly, in this alternative embodiment, the device for detecting movement of the cam arrangement (eg. limit switch or proximity sensor) is normally open (rather than normally closed) when the pin is inserted, and is closed (rather than opened) when the pin is removed which causes the cam arrangement to move from the first to the second position. In other words, the step of detecting (by the device for detecting movement of the cam arrangement) that the cam arrangement is not in the first position, is not limited to a configuration in which the second cam element causes a switch or sensor to be always closed when the pin is inserted and subsequently opened when the pin is removed. Detecting that the cam arrangement is not in the first position may alternatively involve detecting that the second cam element has opened (rather than closed) a switch or sensor during movement of the cam arrangement from the first to the second position.

In an embodiment, the first and second cam elements are arranged such that the first cam element is positioned adjacent the aperture that receives and accommodates the pin, and the second cam element is positioned adjacent the device for detecting movement of the cam arrangement (eg. limit switch or proximity sensor).

In an embodiment, the cam arrangement is a rotatable cam shaft, the first cam element is a cam shaft lever that rotates together with the cam shaft, and the second cam element is a cam shaft lobe that rotates together with the cam shaft.

In an embodiment, the cam shaft lever is positioned and dimensioned so as not to be obstructed during its rotation from the first to the second position in the aperture.

In an embodiment, the rotatable cam shaft is supported at each of its opposed ends by a cam shaft holder including an associated cam return spring positioned at one end of the cam shaft to cause the cam shaft to be biased in a rotational direction towards said second position, the cam shaft thereby being spring loaded when in said first position.

In an embodiment, the cam shaft lever and cam shaft lobe are spaced apart along the length of the cam shaft.

In an embodiment, the device for detecting movement of the cam arrangement (eg. the limit switch or proximity sensor) is hard wired or wirelessly connected to a communication module operable to receive a signal when the device for detecting movement of the cam arrangement is actuated (ie. opened or closed depending on the particular configuration) based on the pin being removed, and to transmit data relating to said actuation (removal of the pin) to a remote monitoring service.

In an embodiment, the communication module is affixed to the fire extinguisher.

In a second aspect, the present invention provides a fire extinguisher handle including a pin pull sensor assembly configured in accordance with any one of the preceding statements of invention.

In a third aspect, the present invention provides a fire extinguisher that includes a handle configured in accordance with the preceding statement of invention.

In a fourth aspect, the present invention provides a computer-implemented method of detecting removal of a locking pin from the handle of a portable fire extinguisher that includes a pin pull sensor assembly configured in accordance with one or more of the preceding claims, the method including, receiving, by a communication module associated with the fire extinguisher, from the device for detecting movement of the cam arrangement, a first signal indicating that the cam arrangement is not in the first position, and based on receiving the first signal, transmitting, by the communication module, a second signal to a remote monitoring service, the second signal including confirmation regarding removal of the pin from the fire extinguisher handle.

In an embodiment, the method further includes, processing, by the communication module, the first signal to identify information relating to the pin removal including at least a date and time associated with the pin removal, wherein transmitting a second signal to the remote monitoring service includes transmitting the information relating to the pin removal including the date and time associated therewith.

In an embodiment, the method further includes, storing data relating to pin removal instances locally (eg. in one or more local databases) or remotely (eg cloud storage), wherein such data is accessible to users via a data communications device capable of connecting to the remote monitoring service via an available network.

### BRIEF DESCRIPTION OF THE DRAWINGS

Embodiments of the invention will now be described in further detail with reference to the accompanying figures in which:

FIG. 1 illustrates a top perspective view of a portable fire extinguisher of the type that contains pressurized fire extinguishing material, including an enlarged perspective view of the fire extinguisher handle, an associated locking pin that requires removal to arm the extinguisher ready for use, and a pin pull sensor assembly configured in accordance with an embodiment of the present invention.

FIG. 2 illustrates an exploded, underside perspective view of the pin pull sensor assembly of FIG. 1.

FIG. 3 illustrates an assembled, underside perspective view of the pin pull sensor assembly of FIG. 1.

FIG. 4A illustrates a cross sectional view of the pin pull sensor assembly of FIG. 1 including an aperture in which the end of the fire extinguisher locking pin is inserted, and a cam arrangement located in a first position in which a cam lever is spring biased against the pin and a limit switch is mechanically closed through contact with a cam lobe.

FIG. 4B illustrates a further cross-sectional view of the pin pull sensor assembly of FIG. 1, wherein the end of the fire extinguisher locking pin has been removed from the aperture, thereby causing the cam arrangement to rotate towards a second position in which the limit switch is open, wherein opening of the limit switch confirms that the cam arrangement has moved away from the first position and the pin therefore removed from the aperture.

FIG. 5 illustrates a schematic diagram of a fire extinguisher including the pin pull sensor assembly illustrated in FIGS. 1 to 4, the fire extinguisher further including a communication module operable to receive a signal when the limit switch is opened based on removal of the pin, and to transmit data relating to opening of the limit switch to a remote monitoring service which enables access to such data via an available network.

### DETAILED DESCRIPTION OF EMBODIMENT(S) OF THE INVENTION

For simplicity and illustrative purposes, the present disclosure is described by reference to embodiments thereof. In the following description, numerous details are set forth in order to provide a thorough understanding of the present disclosure. It will be readily apparent however, that the present disclosure may be practiced without limitation to the specific details of the one or more embodiments. In other instances, some features, or aspects thereof, have not been described in detail to avoid unnecessarily obscuring the present disclosure.

The present invention relates to a pin pull sensor assembly (100) for a fire extinguisher (105) of the type that includes a handle (110) used to operate the fire extinguisher (105), wherein the handle (110) includes a locking pin (115) positioned to prevent the handle (110) from being operated such that arming of the fire extinguisher (105) requires removal of the pin (115).

According to an aspect, the pin pull sensor assembly (100) includes an aperture (120) for accommodating the end of the pin (115) that extends through the handle (110), and a biased cam arrangement (125) (eg. rotatably biased cam shaft) that is movable between a first position (130) in which the end of the fire extinguisher locking pin (115) is inserted in the aperture (120), and a second position (155) in which the pin (115) is no longer inserted in the aperture (120), eg. based on partial or full removal of the pin (115) from the fire extinguisher handle (110).

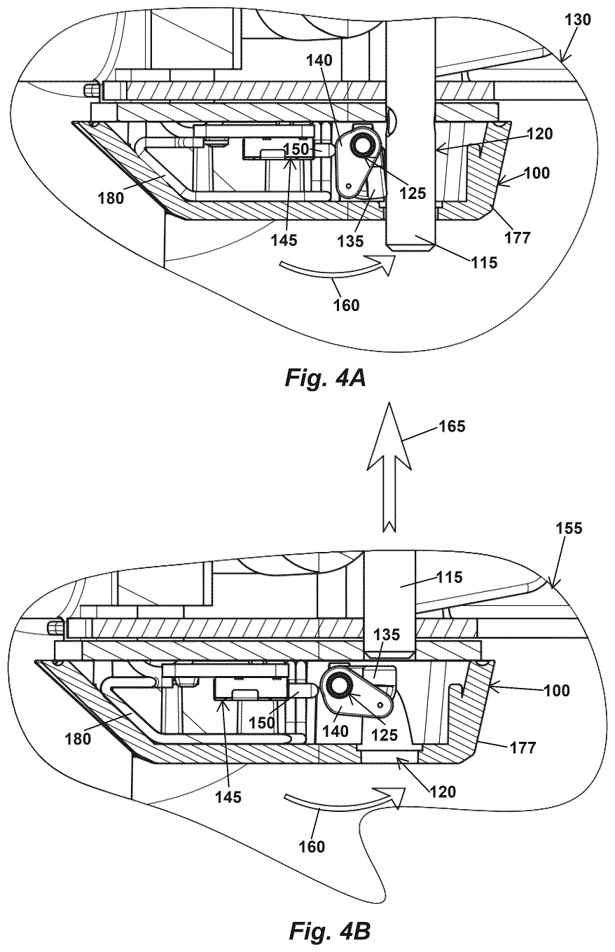

In the first position (130), which is shown in FIG. 4A, a first cam element (135) (eg. a cam lever) associated with the cam arrangement (125) is biased towards the aperture (120) and therefore abuts against the inserted pin (115) which is in the path of the first cam element (135), and a second cam element (140) (eg. a cam lobe) associated with the cam arrangement (125) is positioned to enable a device for detecting movement (rotation) of the cam arrangement (145) (eg. a limit switch, proximity sensor, etc) to detect that the cam arrangement (125) is in the first position (130).

In the second position, which is shown in FIG. 4B, the second cam element (140) (eg. cam lever) is positioned to enable the device for detecting movement (rotation) of the cam arrangement (145) (eg. limit switch, proximity sensor, etc) to detect that the cam arrangement (125) is no longer in the first position (130) and hence that the pin (115) has been retrieved from aperture (120).

Accordingly, it will be appreciated that the cam arrangement (125) is rotatably biased in a direction (160) towards the second position (155) such that the cam arrangement (125) is caused to rotate from the first position (130) to the second position (155) when the end of the fire extinguisher locking pin (115) is removed in direction (165) from the aperture (120). This enables the device for detecting rotation of the cam arrangement (145) to be used to detect that the cam arrangement (125) is no longer in the first position and hence that the pin (115) has been removed. In other words, the assembly (100) provides a means by which to detect when a locking pin (115) associated with a fire extinguisher handle (110) has been removed or partially removed from its intended location.

There may be various reasons for the pin (115) to be removed or partially removed. For example, the pin (115) could be removed as a result of the fire extinguisher (105) requiring utilization to extinguish a fire, ie. for legitimate purposes. In other instances, the pin (115) could be removed for illegitimate reasons, including when individuals tamper with the fire extinguisher (105). Irrespective of the reason for the locking pin (115) being removed (165), the pin pull sensor assembly (100) will detect removal of the pin based on detecting rotation (160) of the cam arrangement (125) from the first to the second position as described above.

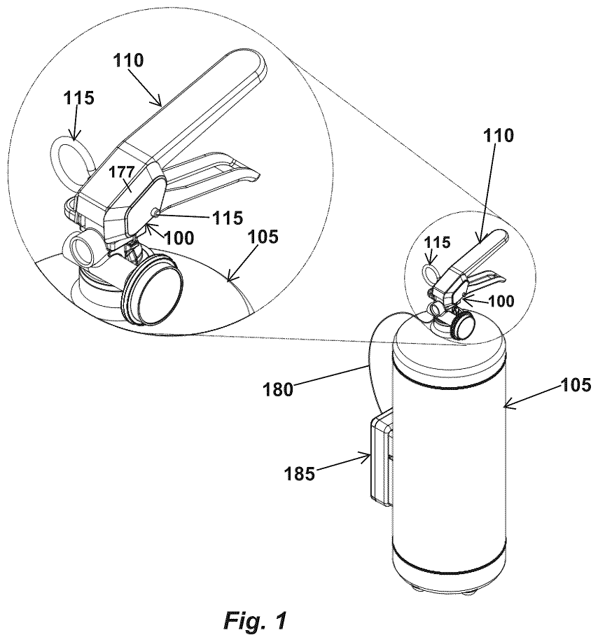

In the particular embodiment illustrated in FIGS. 1 to 5, the device for detecting rotation of the cam arrangement is a limit switch (145) including an actuator (150) in the form of a mechanical pin. However, it is to be understood that any other switching or sensing device may be utilized to detect rotation of the cam arrangement (125), including for example a proximity sensor, as described in greater detail below.

The reader will also appreciate that in the embodiment shown in FIGS. 1 to 5, the cam arrangement (125) is a rotatable cam shaft, the first cam element (135) is a cam shaft lever that rotates together with the cam shaft (125), and the second cam element (140) is a cam shaft lobe that also rotates with the cam shaft (125). Again, it is to be understood that variations to the cam arrangement and cam elements are possible and such variations remain within the scope of the present disclosure.

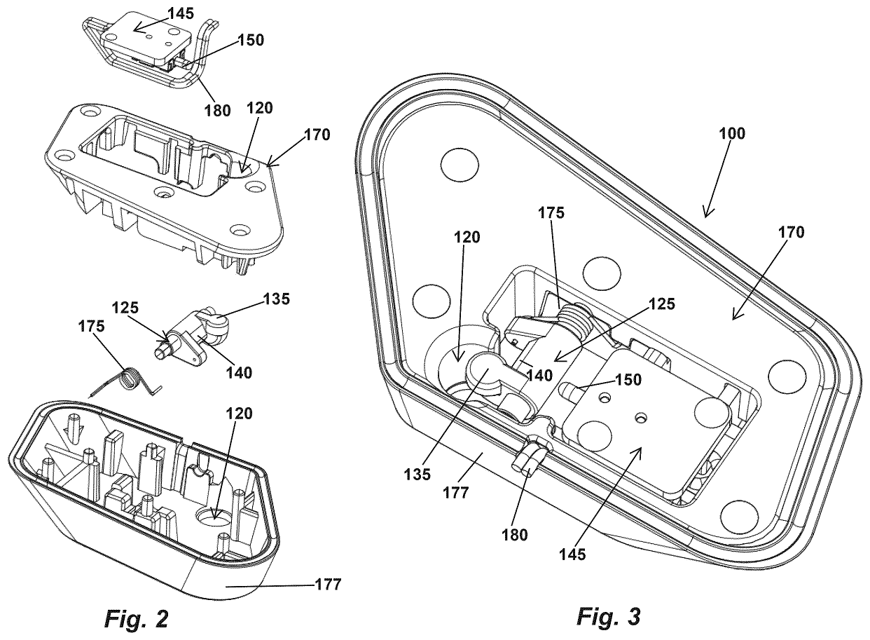

As shown clearly in FIGS. 2-3, the pin pull sensor assembly (100) includes a holder (170) for the cam arrangement (125). The holder (170) is a structural member that is configured to support additional components described herein, including the device for detecting rotation of the cam arrangement (145) (eg. a limit switch, proximity sensor, etc).

The holder (170) is dimensioned to be housed inside a sensor housing (177) which is configured to be mounted to the side of the fire extinguisher handle (110) through which the end of the locking pin (115) extends, as shown most clearly in the enlarged perspective view of FIG. 1. As previously described, the pin (115) that is associated with the fire extinguisher handle (110) (and which is required to be removed in order to arm the fire extinguisher (105)) includes a free end that extends beyond the side of the handle (110) and into the aperture (120) associated with the cam arrangement holder (170).

The holder (170) includes various additional housing components including means of accommodating fasteners such as screws, and reinforcing components which add strength to the structure and ensure that components mounted therein are securely housed. Further, there may be additional features associated with the housing and internal components that are not necessarily described herein in the interest of brevity.

It will also be appreciated that components such as the device for detecting rotation of the cam arrangement (145) (eg. limit switch, proximity sensor, etc) may include additional protective features in order to satisfy product standards, including but not limited to achieving a minimum Ingress Protection (IP) rating. For example, a limit switch may be required to satisfy an IP66 rating which ensures that the switch is “dust tight” and capable of protection against powerful jets of water.

FIG. 4A shows an enlarged cross-sectional view of the first position (130) of the cam arrangement (125), namely, when the end of the fire extinguisher locking pin (115) is fully inserted into aperture (120). FIG. 4B shows an enlarged cross-sectional view of the second position (155) of the cam arrangement (125) after the fire extinguisher locking pin (115) has been removed in direction (165) from inside the aperture (120). In the description that follows in relation to FIGS. 4A and 4B, the cam arrangement (125) will be referred to in accordance with the specific embodiment shown in which the cam arrangement is a cam shaft. Similarly, in accordance with the specific embodiment shown, the first cam element (135) will be referred to as a cam lever, the second cam element (140) will be referred to as a cam lobe, and the device for detecting rotation of the cam arrangement (145) will be referred to as a limit switch. However, it is to be understood that reference to such components is exemplary and is not intended to limit the scope of the present disclosure.

The limit switch (145) is configured to detect that the cam shaft (125) has been rotated away from the first position (130) to the second position (155). The location of the cam shaft (125) in the first position (130) is detected based on the limit switch actuator pin (150) (also known as a trigger pin) being closed by the cam lobe (140), as shown in FIG. 4A. Opening of the limit switch (145) occurs when the cam shaft (125) rotates to the second position (155) based on the cam shaft (125) and hence the cam lobe (140) being rotated to an extent that the cam lobe (140) no longer effects closing of the actuator pin (150), as shown in FIG. 4B. Accordingly, in the particular embodiment shown, the switch (145) is normally closed, ie. when the pin (115) is inserted, and is opened when the cam lobe (140) is caused to rotate away from the limit switch (145) as a result of the cam shaft (125) rotating from the first (130) to the second (155) position when the pin (115) is removed in direction (165). The skilled addressee will understand that such switches only require their actuator pins to be displaced by a very short distance (eg. approximately 1 millimeter) to effect transition from a closed to an opened state, and vice versa, hence the cam lobe (140) is only required to have a small lobe height sufficient to cause the limit switch actuator pin (150) to be depressed when appropriately aligned in the first position (130).

In an alternative embodiment which is not shown in the accompanying Figures, the device for detecting rotation of the cam arrangement (145) may include an alternative detection means. For example, this component may be a proximity sensor or another similar device that detects the presence of objects within a particular vicinity. In the case of a proximity sensor, the detected presence of the cam shaft lobe (140), or similar object associated with the cam shaft within a particular vicinity of the sensor (ie. when the pin (115) is inserted) may be sufficient to cause the proximity sensor to be closed. In this embodiment, movement of the lobe or similar cam shaft component out of the particular vicinity of the proximity sensor (ie. when the pin is removed) may be sufficient to cause the proximity sensor to be opened. Other variations are possible in this regard. For example, sensors that do not require any additional energy source such as magnetic switches or light/laser sensors could also be utilized.

It is to be further understood that the normally closed configuration of the limit switch (145) shown in FIGS. 4A and 4B and described above is by way of example only. For example, the limit switch (145) could equally be “normally open” and positioned elsewhere inside the housing such that when the pin (115) is removed to cause the cam shaft (125) to rotate from the first to the second position, rotation of the cam lobe (140) may cause the limit switch (or sensor) to be actuated (closed). In this way, detecting that the cam shaft (125) is not in the first position may alternatively involve detecting that the cam shaft lobe (140) has opened (rather than closed) a switch or sensor during rotation of the cam shaft (125) from the first (130) to the second (135) position. It is to be understood that such variations may be possible and are considered within the scope of the present disclosure.

As shown most clearly in FIG. 3, the rotatable cam shaft (125) may be maintained in a biased configuration in direction (160) towards the second position (155) using a cam return spring (175). The cam return spring (175) is positioned at one end of the cam shaft (125) and attached to the cam shaft holder (170) in a configuration that causes the cam shaft (125) to be biased in the rotational direction (160) towards the second position (155), and thereby causes the cam shaft (125) to be spring loaded when forced into said first position (130) by the insertion of pin (115). It is to be understood that biasing of the cam arrangement (125) may be achieved using other appropriate biasing means without deviating from the scope of the present disclosure. For example, molded plastic springs (not shown) linked with the cam arrangement (125) could equally be used (eg. where aperture (120), first cam element (135) and second cam element (140) are integrated with a molded spring to form a single component).

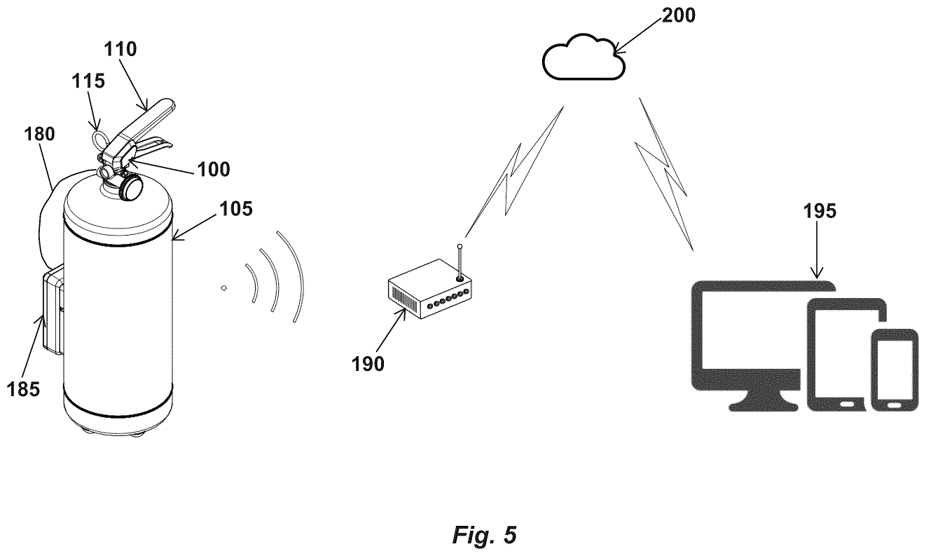

FIG. 5 illustrates an example of one of the advantages of the present invention, being the ability to remotely detect removal or partial removal of the locking pin (115) from a particular fire extinguisher (105). In particular, the limit switch (145) is hard wired (180) to a communication module (185) which is affixed to the fire extinguisher body (105), the communication module (185) operable to receive a signal from the limit switch (145) when the limit switch (145) is actuated (ie. opened or closed depending on the particular configuration) in a manner that indicates that the pin (115) has been removed, and to transmit data relating to actuation of the switch (triggered by removal of the pin (115) from aperture (120)) to a remote monitoring service (190).

The signal from the limit switch (145) may be processed, either by the module (185) or at the remote monitoring service (190), to identify information relating to the removal of the pin (145). This may include, for example, a location of the fire extinguisher (105) affected, and a date and time associated with the pin removal (165). Such information may be subsequently forwarded to relevant user devices (195) via an available network (200) for the purpose of allowing users to act upon such information.

For example, the receiving devices (195) may be the property of remote emergency personnel or on-site personnel who are capable of addressing fire emergencies or equipment inspection/maintenance. There are clear benefits associated with being able to notify such personnel in substantially real-time, including in relation to the removal of pins (115) from particular fire extinguishers (105). For example, since the location of an affected fire extinguisher (105) will be known, such notifications may enable immediate dispatch of appropriate personnel to the location, including from fire departments, police departments and other relevant authorities.

One of the benefits associated with being able to notify relevant on-site personnel is that the presence of a fire emergency can be quickly assessed. In particular, on-site personnel can check whether removal of a fire extinguisher pin (115) was for a legitimate reason, ie. so that the fire extinguisher (105) could be utilized to extinguish a fire, or whether removal of the pin (115) was illegitimate, eg. based on an individual tampering with the fire extinguisher (105), or a false alarm. All data collected and transmitted by the communication module (185) may be subsequently stored such that a historical database of events is maintained. The skilled addressee will appreciate that such data is also useful for analytical purposes, including to improve processes, for report generation, etc.

It will be apparent to the person skilled in the relevant field of technology that the pin pull sensor (100) of the present invention may be installed in newly manufactured fire extinguishers (105), but may also be easily retrofitted into existing fire extinguishers (105) since no part of the existing fire extinguisher (105) and/or handle (110) needs to be re-configured in order for the assembly (100) to be utilized. The assembly (100) simply needs to be mounted to the side of the handle (110) such that the end of the existing fire extinguisher locking pin (115) extends into aperture (120). At most, some minor modifications may need to be made to the handle (110) to ensure that the assembly (100) is securely mounted. It will also be appreciated that different fire extinguishers have different handles, pin diameters, etc, hence the assemblies (100) may be constructed accordingly in order to accommodate existing parameters.

The benefits of the present invention should now be realized. What is provided is a digitized means of detecting the partial or full removal of a fire extinguisher pin (115) from a fire extinguisher handle (110), which enables connection to a monitoring platform such that removal of the pin (115) is remotely monitored without the need for regular maintenance inspections.

It will be appreciated by persons skilled in the relevant field of technology that numerous variations and/or modifications may be made to the invention as detailed in the embodiments without departing from the spirit or scope of the invention as broadly described. The present embodiments are, therefore, to be considered in all aspects as illustrative and not restrictive.

Throughout this specification and claims which follow, unless the context requires otherwise, the word “comprise”, and variations such as “comprises” and “comprising”, will be understood to imply the inclusion of a stated feature or step, or group of features or steps, but not the exclusion of any other feature or step or group of features or steps.

1. A pin pull sensor assembly for a fire extinguisher including a handle to operate the fire extinguisher, the handle including a pin positioned to prevent the handle from operation such that arming the fire extinguisher requires removal of the pin, the pin pull sensor assembly including:
an aperture for accommodating an end of the pin that is removeable from the fire extinguisher handle to arm the fire extinguisher;
a biased cam arrangement that is moveable between:
a first position in which:
the end of the fire extinguisher pin resides in the aperture,
a first cam element of the cam arrangement is biased towards the aperture and abuts against the inserted pin which resides in the path of the first cam element, and
a second cam element of the cam arrangement is positioned to enable a device for detecting movement of the cam arrangement to detect when the cam arrangement is in the first position, and
a second position in which:
the end of the fire extinguisher pin is removed from the aperture, and
the second cam element is positioned to enable the device for detecting movement of the cam arrangement to detect that the cam arrangement is not in the first position; and
wherein the cam arrangement is biased toward the second position such that the cam arrangement is caused to move from the first position to the second position when the end of the pin is removed from the aperture, thereby enabling the device for detecting movement of the cam arrangement to detect that the cam arrangement is not in the first position.

2. The pin pull sensor assembly of claim 1, wherein the cam arrangement is rotatably moveable between the first and second positions, and the device for detecting movement of the cam arrangement is a device for detecting rotation of the cam arrangement.

3. The pin pull sensor assembly of claim 2, wherein the device for detecting rotation of the cam arrangement is a limit switch.

4. The pin pull sensor assembly of claim 2, wherein the device for detecting rotation of the cam arrangement is a proximity sensor configured to be actuated based on detecting the presence of the cam arrangement within a predetermined vicinity of the proximity sensor.

5. The pin pull sensor assembly of claim 3, wherein the limit switch is configured to detect that the cam arrangement is in the first position based on a limit switch actuator being closed by the second cam element when the cam arrangement is in the first position.

6. The pin pull sensor assembly of claim 5, wherein the limit switch is configured to detect that the cam arrangement is in the second position based on the second cam element being rotated away from the limit switch to an extent that causes the limit switch actuator to be opened.

7. The pin pull sensor assembly of claim 3, wherein the limit switch is configured to detect that the cam arrangement is in the first position based on a limit switch actuator being opened by the second cam element when the cam arrangement is in the first position.

8. The pin pull sensor assembly of claim 7, wherein the limit switch is configured to detect that the cam arrangement is in the second position based on the second cam element being rotated towards the limit switch to an extent that causes the limit switch actuator to be closed.

9. The pin pull sensor assembly of the preceding claims of claim 1, wherein the first and second cam elements are arranged such that the first cam element is positioned adjacent the aperture that receives and accommodates the pin, and the second cam element is positioned adjacent the device for detecting movement of the cam arrangement.

10. The pin pull sensor assembly of claim 1, wherein the cam arrangement is a rotatable cam shaft, the first cam element is a cam shaft lever that rotates together with the cam shaft, and the second cam element is a cam shaft lobe that rotates together with the cam shaft.

11. The pin pull sensor assembly of claim 10, wherein the cam shaft lever is positioned and dimensioned so as not to be obstructed during its rotation from the first to the second position in the aperture.

12. The pin pull sensor assembly of claim 11, wherein the rotatable cam shaft is supported at each of its opposed ends by a cam shaft holder including an associated cam return spring positioned at one end of the cam shaft to cause the cam shaft to be biased in a rotational direction towards said second position, the cam shaft thereby being spring loaded when in said first position.

13. The pin pull sensor assembly of claim 10, wherein the cam shaft lever and cam shaft lobe are spaced apart along the length of the cam shaft.

14. The pin pull sensor assembly of claim 1, wherein the device for detecting movement of the cam arrangement is hard wired or wirelessly connected to a communication module operable to receive a signal when the device for detecting movement of the cam arrangement is actuated based on the pin being removed, and to transmit data relating to said actuation to a remote monitoring service.

15. The pin pull sensor assembly of claim 14, wherein the communication module is affixed to the fire extinguisher.

16. A fire extinguisher handle including the pin pull sensor assembly configured in accordance with claim 1.

17. A fire extinguisher that includes the handle configured in accordance with claim 16.

18. A computer-implemented method of detecting removal of a locking pin from the handle of a portable fire extinguisher that includes a pin pull sensor assembly configured in accordance with one or more of the preceding claims, the method including:
receiving, by a communication module associated with the fire extinguisher, from the device for detecting movement of the cam arrangement, a first signal indicating that the cam arrangement is not in the first position; and
based on receiving the first signal, transmitting, by the communication module, a second signal to a remote monitoring service, the second signal including confirmation regarding removal of the pin from the fire extinguisher handle.

19. The computer-implemented method of claim 18, further including:
processing, by the communication module, the first signal to identify information relating to the pin removal including at least a date and time associated with the pin removal, wherein transmitting a second signal to the remote monitoring service includes transmitting the information relating to the pin removal including the date and time associated therewith.

20. The computer-implemented method of claim 18, further including:
storing data relating to pin removal instances in a local or remote database, wherein such data is accessible to users via a data communications device capable of connecting to the remote monitoring service via an available network.
